(19) United States
(12) Patent Application Publication
(10) Pub. No.: US 2018/0203973 A1
(43) Pub. Date: Jul. 19, 2018

(54) SYSTEM AND SIMULATOR FOR THE DISENGAGEABLE SIMULATION OF INSTALLATIONS OR MACHINES WITHIN PROGRAMMABLE LOGIC CONTROLLERS

(71) Applicant: Siemens Aktiengesellschaft, Munchen (DE)

(72) Inventors: RENE ERMLER, ERLANGEN (DE); CORNELIA KREBS, RUCKERSDORF (DE); JÖRG NEIDIG, NURNBERG (DE); GUSTAVO QUIROS ARAYA, PRINCETON, NJ (US)

(21) Appl. No.: 15/869,171

(22) Filed: Jan. 12, 2018

(30) Foreign Application Priority Data
Jan. 16, 2017 (EP) 17151591.9

(51) Int. Cl. G06F 17/50; G05B 19/05

(52) U.S. Cl. CPC G06F 17/5086; G05B 2219/13186; G05B 19/05

(57) ABSTRACT

Provided is a system and a simulator for the disengageable simulation of installations or machines within programmable logic controllers, in which control program and simulation program are strictly separate within the same processing environment, wherein the direction of access for the input/output memory area during normal operation and the consistent reversal thereof in the simulation part are ensured, and which involves the simulation program being executed between the program cycles, with a virtual clock being stopped during the simulation. As a result, the test on an unaltered user program in the PLC avoids errors in the startup or test phase through code changes, and a timing response as in the genuine installation, particularly in the event of tests on timers and under race conditions, achieves a higher level of program quality through better test results.

### CROSS-REFERENCE TO RELATED APPLICATIONS

This application claims priority to European application No. 17151591.9 having a filing date of Jan. 16, 2017, the entire contents of which are hereby incorporated by reference.

### FIELD OF TECHNOLOGY

The following relates to a system and a simulator for the disengageable simulation of installations or machines within programmable logic controllers (PLCs) having an installation interface for a productive mode, which installation interface is present to output installation control data to the installation and to receive installation data from the installation, and having a further interface, separate from the installation interface, for a simulation mode.

### BACKGROUND

In the surroundings of the programmable logic controllers (PLCs), program code is written that controls installations or machines. This code needs to be tested. In order to test realistically, however, the environment in which the controller will later operate needs to be replicated. To this end, a response needs to be produced from the signals that the controller sends to the installation or machine, the signals of said response being consistent with the reality insofar as is necessary for the test. To this end, either a simulation environment is used or the program in the controller is modified such that it generates the expected signals itself. Normally, the installation/machine is set up and used gradually during startup. To check the operability of the controller and of the already present installation parts incrementally, it is necessary to simulate absent parts of the operating environment.

Problems during the use of simulation environments are usually the following: the complexity for setting up a simulation environment is considerable for several reasons, since simulation systems require incorporation because they are programmed in other languages, and since integration of a controller into a simulation system is complex because the signals of the two systems need to be assigned individually and often “manually”. Further, the simulation system is often available only during development, but not in the event of later changes or troubleshooting in the installation. Finally, additional costs arise, since simulation systems require additional computer systems and software also costs money.

Secondly, modification of the control code for the purpose of simulation also entails a few problems: the installation of test logic requires the control code to be changed, which is an additional source of error and makes the control code less clear, i.e. it is no longer the original code that is tested, but rather an adapted code. The test logic is not needed at all in productive mode, or it can be inadvertently activated or deactivation can be forgotten after initiation, which is a source of error, and in test mode the additional test logic corrupts the timing, since the additional code also needs to be executed, of course.

The following three fundamental approaches to a solution are known to date:

a) use of additional simulation products:
there is a broad selection of different products for different fields of use such as AMESim (Siemens), SIMIT (Siemens), Plant Simulation (Siemens), MATLAB/Simulink (Mathworks), etc. In this case, the programmable logic controller is usually embedded as hardware in the loop or software in the loop technology. In the first case, special hardware is used that links the signals of the simulation product, and in the second case, the software PLC has a simulation API provided therefor, that is to say an appropriate programming interface.
b) Modification of modules, that is to say of programming objects in the programmable logic controller, by virtue of combination with a simulation condition, wherein the modules are altered such that a flag is taken as a basis for skipping to alternative code sections. In this case, e.g. particular input signals are ignored or set by altered module code. The supplementary code is removed from the program in the course of startup for the intended operation so that the desired response of the controller is obtained. This is effected unsystematically, however, and is not 100% checkable by virtue of subsequent tests. Now and then, supplementary code that has not been removed feigns incorrect input signals after startup of the controller.
c) Programming of special simulation modules that imitate the response of the installation or machine using PLC code: these modules need to be executed like the control modules by the PLC and generate the response signals from the control signals of the controller. The problem of the changed execution time is accepted in this case.

The European patent application EP 2 980 661 A1, Siemens AG, Rene Ermler, Andreas Matis, Gustavo Quiros Araya, discloses an electronic controller having a control device for the sequence of a control program for controlling installation and having an installation interface for outputting installation control data to the installation and for receiving installation data from the installation, wherein the controller is set up and configured for operation in an emulation mode that can be switched on and off for control of an installation simulation by the control program, and wherein in the emulation mode there is an emulation interface, separate from the installation interface, for outputting the installation control data and for receiving data from the installation simulation.

WO 2015/124170 A1 discloses a method for emulating a programmable logic controller by providing a computation device having an operating system that is inadequate for a realtime demand made on the programmable logic controller. In this case, a real period of time is mapped onto a virtual period of time on the basis of a predetermined function, wherein there is provision for predetermination of a limit value for the virtual period of time required for emulating at least one program cycle of a program of the programmable logic controller, and the at least one program cycle is emulated using the computation device and the circumstance of a cycle time having been exceeded by the emulating program cycle is checked on the basis of the limit value.

EP 2 687 928 A1 discloses a support program for a controller that prompts an arithmetic unit to perform the recording of a total execution time by virtue of a total execution time being recorded and output. The total execution time is an elapsed time that has accumulated up to effected execution of a control program in an execution cycle, since the execution cycle is started when a controller executes the control program according to an execution priority and the execution cycle. In this case, the total execution time is a time that is measured in the controller or a time that is estimated in a control support apparatus.

WO 2012/031859 A1 relates to a control apparatus for controlling devices of a factory installation, comprising a control unit and a simulation device, wherein the control unit can be used to control devices of the factory installation according to a predetermined control routine in a control cycle, and the simulation device of the control apparatus is used to provide simulation, effected in sync with the time frame of the control cycle, of operation of the devices.

### SUMMARY

An aspect relates to a system for the disengageable simulation of installations or machines within the programmable logic controllers in which the aforementioned disadvantages are avoided as far as possible.

The following essentially relates to a system for the disengageable simulation of installations or machines within programmable logic controllers, in which control program and simulation program are strictly separate within the same processing environment, wherein the direction of access for the input/output memory area during normal operation and the consistent reversal thereof in the simulation part are ensured, and which involves the simulation program being executed between the program cycles, with a virtual clock being stopped during the simulation. As a result, the test on an unaltered user program in the PLC avoids errors in the startup or test phase through code changes, and a timing response as in the genuine installation, particularly in the event of tests on timers and under race conditions, achieves a higher level of program quality through better test results. Use of multiple processor cores is likewise possible. Since the simulator runs in the same controller as the actual control code, no additional test hardware is required and fast test mode/productive mode changeover furthermore achieves a time saving. If the simulator remains on the controller, test scenarios are available quickly in the event of a fault.

### BRIEF DESCRIPTION

Some of the embodiments will be described in detail, with reference to the following Figures, wherein like designations denote like members, wherein:

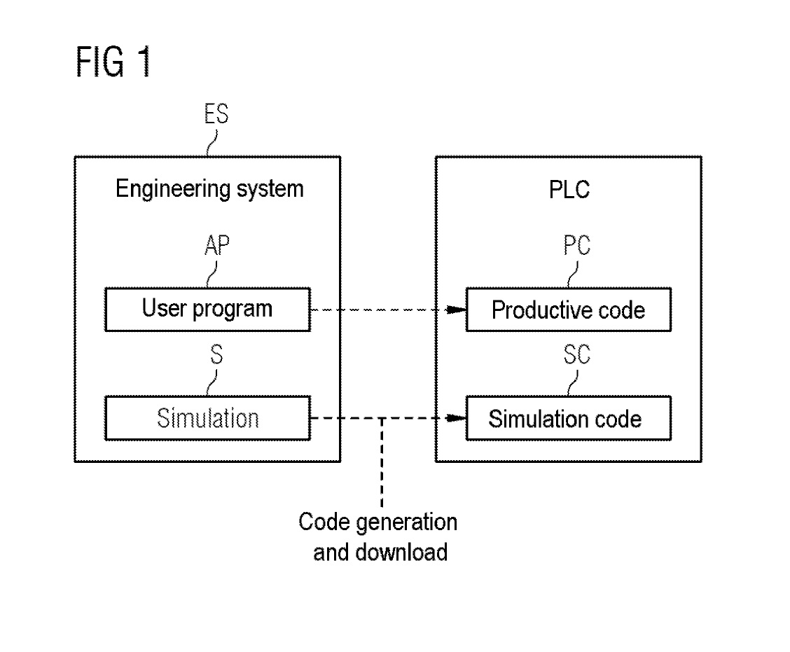

FIG. 1 shows an overview depiction to explain embodiments of the invention in terms of engineering system and programmable logic controller,

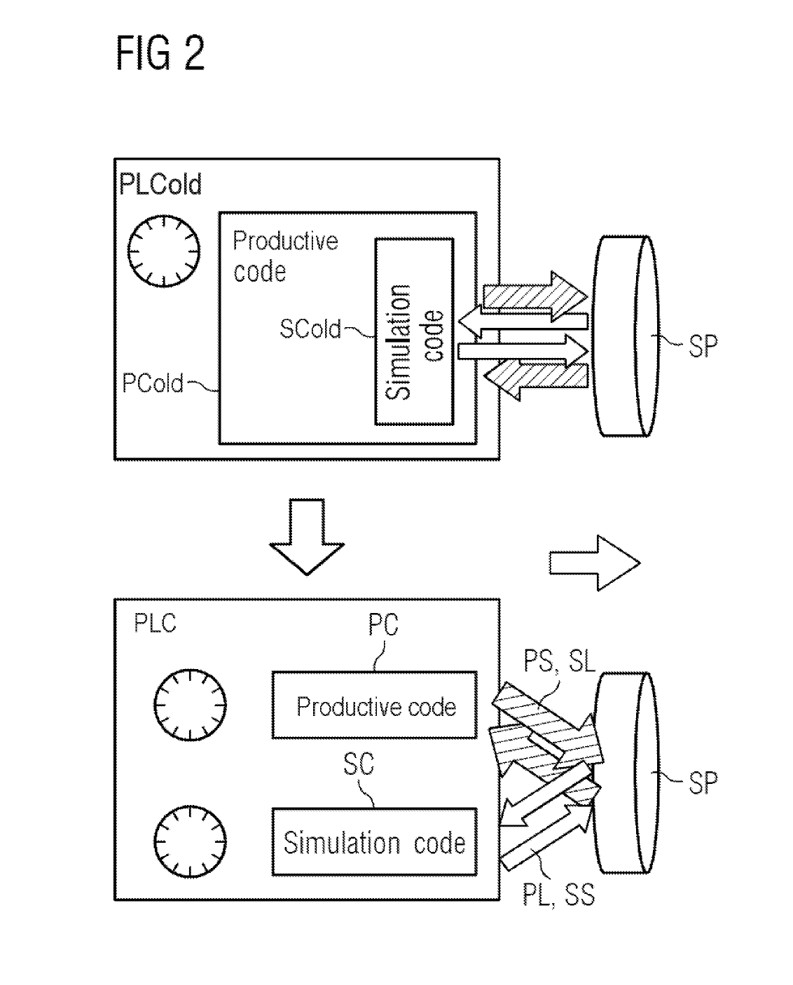

FIG. 2 shows a basic depiction to explain embodiments of the invention in terms of separation of productive code and simulation code and also the interchange of information with the data memory, and

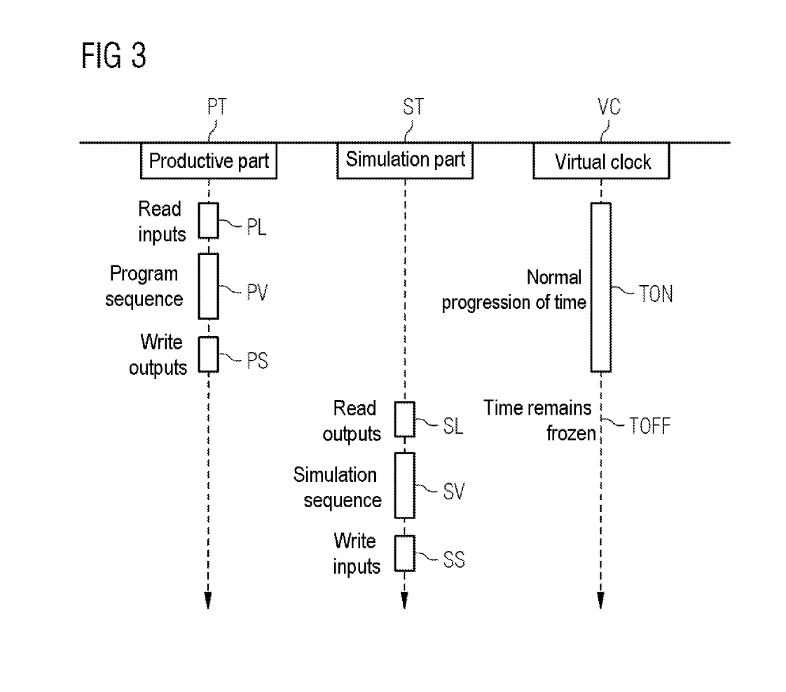

FIG. 3 shows a flowchart to explain embodiments of the invention in terms of the timings in the productive part, in the simulation part and in the virtual clock.

### DETAILED DESCRIPTION

FIG. 1 shows an overview depiction to explain embodiments of the invention in terms of an engineering system ES and programmable logic controller PLC, wherein an application program AP that is present in the engineering system leads to a productive code PC in the programmable logic controller PLC and, separately therefrom, generates a code from a simulation program S in the engineering system ES and, as simulation code SC, is separately likewise loaded into the programmable logic controller PLC.

The simulation code SC is programmed using a PLC language and is executed by an IO simulator that is advantageously integrated in a programmable logic controller PLC.

The IO simulator is part of the controller, runs within the same context and can access the internal data memories within the control system.

To separate the responsibilities, the two parts “productive code” and “simulation code” are distinguished from one another. The PLC manages a simulation code exclusively through the IO simulator. The direct or inadvertent execution of simulation code by the PLC is technically prevented. Only the IO simulator is still provided with the special rights cited below such as e.g. modifying input signals.

FIG. 2 shows a basic depiction to explain embodiments of the invention. To better clarify the differences, the top part of FIG. 2 depicts a programmable logic controller PLC_{old} with a previous productive code PCold that also includes the previous simulation code SCold.

By contrast, the bottom part of FIG. 2 depicts a programmable logic controller PLC according to embodiments of the invention with a productive code PC and the separate simulation code SC, wherein the productive code PC reads PL input information from a memory SP and writes PS output information to the memory SP and wherein simulation code SC conversely reads SL at least one portion of the output information from the memory SP and writes SS new input information to the memory SP.

FIG. 3 shows a flowchart to explain the timings in the productive part PT, in the simulation part ST and in the virtual clock VC in an inventive system.

In the productive mode, or in the productive part PT, input information is read PL from the memory SP, at least one portion of this input information is processed PV during a respective program sequence and is then written PS to the memory SP as output information.

The unchanged user program computes the new outputs on the basis of the inputs. During the computation, the virtual clock VC continues to run normally TON, i.e. the timing of the program sequence is unchanged. In a productive mode, no simulation is computed. The control code is executed in real time.

In the simulation/startup mode, or in the simulation part ST, output information is read SL from the memory SP, at least one portion of this output information is processed SV and is then written SS to the memory SP as input information.

In the simulation part ST, the simulation modules of the IO simulator, in contrast to the productive part PT, access the IO memory areas. The simulation is computed between the program cycles and therefore does not corrupt the normal operating response. The PLC code is executed on the basis of the virtual clock VC, which functions as a stopwatch and does not progress during the simulation TOFF. Therefore, the timing of the actual program does not change either as a result of the execution of the simulation code. The execution of the simulation modules is deactivatable depending on the scenario (developments/test/production).

After a sequence of the user program, the virtual clock VC stops and the simulation procedure begins. The simulation computes the new inputs on the basis of the outputs. Thereafter, the cycle begins again with the sequence of the user program and continuation of the normal timing. As a result of the virtual clock, the simulation is computed practically “between” the cycles, which means that the simulation accuracy is improved, since the timing (cycle times, jitter, etc.) is therefore not corrupted.

The execution times of the simulation are not relevant to the consideration of program execution time.

As a result of embodiments of the invention, it is not necessary to remove program parts, since the IO simulator is simply disengaged by the change of mode of operation, removing the lack of clarity in the otherwise required program additions, for example. The “disengaging” of the IO simulator deactivates all components of the simulation code and hence any unintentional manipulation of the process data. The clock runs constantly.

Additionally, it is possible to individually activate the use of the simulation and startup modules, so that subregions of the installation can be simulated, while other parts are already complete and are used directly. The simulation modules are also available after startup of the installation for later operation. In this case, the timing response changes as a result of the additional complexity of the simulation of subregions. Stopping the clock is no longer possible in this case, since the time bases of the simulation and of the real installation parts are then different than one another.

Optionally, user program and simulator can also be executed on separate processor cores of the PLC.

A corresponding simulator can be sold as a separate product, e.g. with separate licenses for engineering and execution time.

The IO simulator can be deactivated by a simple mechanism at one point. The system is designed so that when the IO simulator is deactivated, there is the certainty that no further simulation code is executed.

The execution of the simulation code is separate from the execution of the productive code, which means that there is no possibility of confusion.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A system for disengageable simulation of installations or machines within a programmable logic controller, comprising:
a simulation part and a productive part, wherein a respective simulation sequence in the simulation part is provided between two respective program sequences in the productive part,
wherein the programmable logic controller includes a memory for a separate storage of a productive code of a user program and of a simulation code produced by a simulation program, and a virtual clock that is configured for normal operation in the productive part and for stoppage in the simulation part.

2. The system as claimed in claim 1, wherein:
the productive part has input information that is readable from the memory and at least one portion of which is processable during a respective program sequence and then writable to the memory as output information, and
the simulation part has output information that is readable from the memory and at least one portion of which is processable during a simulation sequence and then writable to the memory as input information.

3. The system as claimed in claim 1, wherein the installation is divided into subregions and appropriate simulation/startup modules are present for the subregions, and in which as yet unfinished subregions of the installation are simulatable by virtue of the applicable simulation/startup modules being provided for individual activation and other, already finished, subregions being provided for direct use.

4. The system as claimed in claim 1, wherein the programmable logic controller has processor cores on which the user program and the simulator are each separately executable.

5. A simulator for a system for disengageable simulation of installations or machines within the programmable logic controller as claimed in claim 1, the simulator integrated in the programmable logic controller such that the simulator is provided for programming in a PLC language of the programmable logic controller and for generation of a control code that is loadable into the programmable logic controller and executable therein.

6. The simulator as claimed in claim 5, comprising a mechanism for preventing execution of the whole simulation code by means of deactivation that needs to be performed only at one point.
